(19) United States
(12) Patent Application Publication
(10) Pub. No.: US 2026/0278817 A1
(43) Pub. Date: Sep. 17, 2026

(54) JOINT INSTANCE SEGMENTATION AND INSTANCE DEPTH ESTIMATION

(71) Applicant: QUALCOMM Incorporated, San Diego, CA (US)

(72) Inventors: Xiaowen YING, San Diego, CA (US); Xin LI, San Diego, CA (US); Yingyong QI, San Diego, CA (US)

(21) Appl. No.: 19/566,793

(22) Filed: Mar. 13, 2026

Related U.S. Application Data
(60) Provisional application No. 63/773,380, filed on Mar. 17, 2025.

(51) Int. Cl. G06T 7/50; G06T 7/10

(52) U.S. Cl. CPC G06T 7/50; G06T 7/10; G06T 2207/20016; G06T 2207/20081; G06T 2207/20084; G06T 2207/30196

(57) ABSTRACT

Systems and techniques are provided for image processing. For instance, a computing device can process an image using one or more convolutional layers and one or more transformer blocks to generate a set of weights; generate, based on the set of weights, an instance mask for an object in the image and a depth for the object, wherein the depth is associated with the instance mask; and output the instance mask and the associated depth for the object.

### CROSS-REFERENCE TO RELATED APPLICATIONS

This application claims the benefit of U.S. Provisional Patent Application No. 63/773,380, filed Mar. 17, 2025, which is hereby incorporated by reference, in its entirety and for all purposes.

### FIELD

The present application is related to image processing. For example, aspects of the present application relate to systems and methods for performing joint instance segmentation and instance depth estimation.

### BACKGROUND

Many devices and systems allow image and/or video data to be processed, and this processed output may be used for a variety of operations, such as local mapping, object avoidance, virtually interacting with or responding to objects in the environment, and a host of other operations. One process that may be performed on images and/or video is object segmentation. Object (or image) segmentation may divide (e.g., segment) an image into groups (e.g., sub-images, image segments, etc.) represented by a mask or label. In some cases, the segments may correspond to objects or other elements of the environment. For example, one segment may correspond to people in the image, another segment may correspond to a background of the image, another segment may correspond to trees in the image, and so forth. The segmented objects/elements may then be output for use by other applications.

Currently known technologies for identifying relative depth of the segmented objects/elements in the image include monocular depth estimation system, which limits their usability in real world scenarios. Additionally, pixel level depth prediction using the currently known technologies is inefficient and difficult, using training and deploying complex systems.

### SUMMARY

Systems and techniques are described herein for image processing. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for image processing. In some aspects, an apparatus for image processing is provided. The apparatus includes at least one memory and at least one processor coupled to the at least one memory and configured to: obtain an image of an environment; process the image using one or more convolutional layers and one or more transformer blocks to generate one or more instance masks for the image; generate a depth for a respective instance associated with an instance mask of the one or more instance masks; and output the one or more instance masks and the depth for each instance associated with each instance mask of the one or more instance masks.

In some aspects, a method for image processing is provided. The method includes: obtaining an image of an environment; processing the image using one or more convolutional layers and one or more transformer blocks to generate one or more instance masks for the image; generating a depth for a respective instance associated with an instance mask of the one or more instance masks; and outputting the one or more instance masks and the depth for each instance associated with each instance mask of the one or more instance masks.

In some aspects, a non-transitory computer-readable medium having stored thereon instructions that, when executed by at least one processor, cause the at least one processor to: obtain an image of an environment; process the image using one or more convolutional layers and one or more transformer blocks to generate one or more instance masks for the image; generate a depth for a respective instance associated with an instance mask of the one or more instance masks; and output the one or more instance masks and the depth for each instance associated with each instance mask of the one or more instance masks.

In some aspects, an apparatus for image processing is provided. The apparatus includes: means for obtaining an image of an environment; means for processing the image using one or more convolutional layers and one or more transformer blocks to generate one or more instance masks for the image; means for generating a depth for a respective instance associated with an instance mask of the one or more instance masks; and means for outputting the one or more instance masks and the depth for each instance associated with each instance mask of the one or more instance masks.

In some aspects, an apparatus for image processing is provided. The apparatus includes at least one memory and at least one processor coupled to the at least one memory and configured to: process an image using one or more convolutional layers and one or more transformer blocks to generate a set of weights; and generate, based on the set of weights, an instance mask for an object in the image and a depth for the object, wherein the depth is associated with the instance mask; and output the instance mask and the associated depth for the object.

In some aspects, a method for image processing is provided. The method includes: processing an image using one or more convolutional layers and one or more transformer blocks to generate a set of weights; generating, based on the set of weights, an instance mask for an object in the image and a depth for the object, wherein the depth is associated with the instance mask; and outputting the instance mask and the associated depth for the object.

In some aspects, a non-transitory computer-readable medium having stored thereon instructions that, when executed by at least one processor, cause the at least one processor to: process an image using one or more convolutional layers and one or more transformer blocks to generate a set of weights; and generate, based on the set of weights, an instance mask for an object in the image and a depth for the object, wherein the depth is associated with the instance mask; and output the instance mask and the associated depth for the object.

In some aspects, an apparatus for image processing is provided. The apparatus includes: means for processing an image using one or more convolutional layers and one or more transformer blocks to generate a set of weights; means for generating, based on the set of weights, an instance mask for an object in the image and a depth for the object, wherein the depth is associated with the instance mask; and outputting the instance mask and the associated depth for the object.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU) (also referenced as a deep learning processor or an artificial intelligence (AI) accelerator), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure;

FIG. 2A is a diagram illustrating an example of a fully-connected neural network, in accordance with some examples of the present disclosure;

FIG. 2B is a diagram illustrating an example of a locally-connected neural network, in accordance with some examples of the present disclosure;

FIG. 2C is a diagram illustrating an example of a convolutional neural network, in accordance with some examples of the present disclosure;

FIG. 2D is a diagram illustrating an example of a deep convolutional network (DCN) for recognizing visual features from an image, in accordance with some examples of the present disclosure;

FIG. 3 is a block diagram illustrating an example deep convolutional network (DCN), in accordance with some examples of the present disclosure;

FIG. 4A is a block diagram illustrating an example of a machine learning (ML) model for performing image segmentation, in accordance with aspects of the present disclosure;

FIG. 4B is a block diagram illustrating an example of a convolution and transformer-based ML model for performing image segmentation, in accordance with aspects of the present disclosure;

FIG. 5 is a block diagram of a depth head shown in FIG. 4B, in accordance with aspects of the present disclosure;

FIG. 6 is an example illustrating training of query-based instance decoder shown in FIG. 4B, in accordance with aspects of the present disclosure;

FIG. 7 is a flow diagram illustrating a process for image processing, in accordance with aspects of the present disclosure;

FIG. 8 is a flow diagram illustrating a process for image processing, in accordance with aspects of the present disclosure;

FIG. 9A is a block diagram illustrating an example of a convolutional neural network (CNN), in accordance with some aspects of the present disclosure;

FIG. 9B is a block diagram of an example transformer, in accordance with some aspects of the present disclosure; and

FIG. 10 is a diagram illustrating an example of a system for implementing certain aspects of the present disclosure.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, a machine learning (ML) model, such as a convolutional neural network (CNN), a transformer based neural network, a diffusion model, and/or other ML model may be used to perform image segmentation. For example, a CNN for image segmentation may include portions of the CNN trained to detect specific categories of objects/elements, such as one portion trained to recognize the sky, another portion to recognize trees, and so forth. However, such designs can be time consuming to train, as each portion may be trained separately. Additionally, such designs can be relatively inflexible as certain categories may need to be fixed while other categories are trained. As an example, CNN being trained may first be trained to recognize faces, and this portion of the CNN trained to recognize faces may be fixed before another portion of the CNN can be trained to recognize, for example, eyes. In some cases, this can result in lower performance for certain categories as fewer layers may be utilized for later trained categories. Additionally, a CNN may also have to be trained to identify different instances of an object, for example, different persons or instances of an object in the image. Improvements to ML models for performing image segmentation and identifying different instances of an object to help improve model training and flexibility may be useful.

In some cases, image segmentation can be performed using a feature extraction backbone along with additional convolutional layers to form a CNN based solution for image segmentation. However, CNN based image segmentation can be time consuming to train and may have difficulties handling overlapping categories (e.g., a face category overlapping on nose/mouth/eye categories). Additionally, as described herein, identifying multiple different instances of a particular object type, and estimating or predicting relative depth of each instance of the multiple different instances (e.g., using traditional monocular depth estimation systems) can limit the derived information in real-world scenarios. Relative depth estimation using monocular depth estimation systems. while generally scale and shift invariant, can be difficult or inefficient to use to obtain pixel-level predictions.

Transformer-based networks use transformer modules or blocks to process data. In some cases, transformer-based networks use only transformer modules or blocks. In other cases, transformer-based networks can include transformer modules or blocks in combination with other layers, such as one or more convolutional layers, one or more fully connected layers, etc. Transformer-based networks have been explored for image segmentation. Transformer-based networks, in some cases, are neural networks which attempt to learn context about features to try to detect subtle patterns in data to determine how certain portions of the data may influence other portions. As transformer-based networks attempt to detect patterns in data, they can be somewhat easier to train as transformer-based networks may not need labelled datasets to find patterns. In some cases, transformer-based networks may take features as inputs and may tag features. Attention (e.g., self-attention) units of a transformer-based network may be used to track the tagged features to map how different features may be related. However, using transformer-based networks for image segmentation (e.g., with relatively high-resolution images) can be resource intensive due to many redundant calculations, extensive scaling, and/or extensive post-processing. In some cases, it may be useful to combine aspects of CNN based image segmentation with aspects of transformer-based networks to help improve performance of image segmentation.

Systems, apparatuses, electronic devices, methods (also referred to as processes), and computer-readable media (collectively referred to herein as “systems and techniques”) are described herein for a convolution and transformer-based image segmentation and depth estimation of features/objects detected in images. For example, sets of features may be extracted as feature maps by blocks of a CNN based backbone. In some cases, these sets of features may be extracted at different scale resolutions of an input image. Features may be patterns, for example, that may be detected in an image. In some cases, features may be learned. A feature map may represent the features detected along with location information indicating where in the image the feature was detected.

In some cases, a self-attention transform may be performed for pixels of a first feature map to generate similarity scores indicating how similar a pixel of the first feature map is to other pixels of the first feature map. This first feature map may be a relatively low scale resolution feature map. In some cases, the first feature map may be lowest scale resolution feature map extracted from the image. The similarity scores may be added to the first feature map and a convolution operation performed to generate a first feature extractor output. The feature extractor output may also be referenced herein as a pixel decoder output. This first feature extractor output (e.g., the first pixel decoder output) may be up sampled and added to a second feature map (e.g., second pixel decoder output). The second feature map may be a higher resolution feature map. The output of this addition may be up-sampled again for addition with another higher resolution feature map (e.g., pixel decoder output). This may be repeated until the addition is performed with a highest resolution feature map (e.g., pixel decoder output) to generate third feature extractor output (e.g., third pixel decoder output).

In some cases, a cross-attention transform may also be performed on the first feature extractor output. Output of the cross-attention transform may be matrix multiplied with the third feature extractor output to generate instance masks for each detected object instance. Instance classes (or instance categories) may be generated based on the output of the cross-attention transform for each detected object instance.

Additionally, instance depths may also be generated based on the output of the cross-attention transform for each detected object instance. For example, the systems and techniques can predict instance depth (or relative depth for each instance of a particular object type (such as a first person, second person or a first car, second car) in the image in a meter space or other distance or depth metric) consistently across different frames, making the segmentation machine learning model more useful for many application scenarios. The meter space, as referenced herein, is a unit of spatial frequency and refers to the measurement of how quickly image intensity values change across an image. In some cases, the systems and techniques can predict a single depth value for each instance of a particular object type in the image instead of a depth for each pixel of an instance of the particular object type. A single depth value for each instance of the particular object type (e.g., instead of predicting a depth for each pixel in a segmentation map) can be useful for real-world applications in addition to being more robust and cost-effective.

In some aspects, the systems and techniques can perform instance segmentation (or identifying different instances of each object type) and instance depth estimation using a single framework. As a result, drawbacks associated with training and deploying multiple systems to perform the same tasks are avoided. In some cases, the aspects, the systems and techniques can generate robust outputs under different lighting conditions, or irrespective of the lighting conditions.

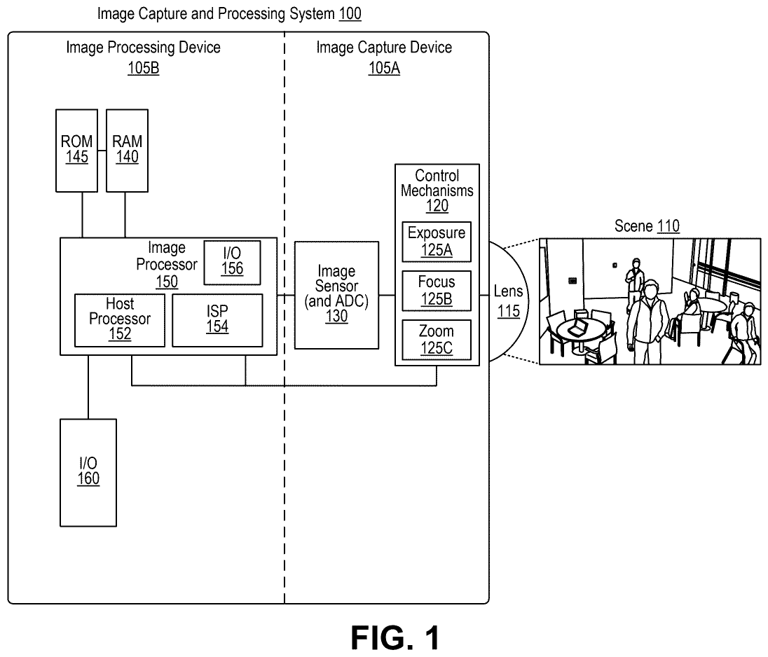

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide-angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

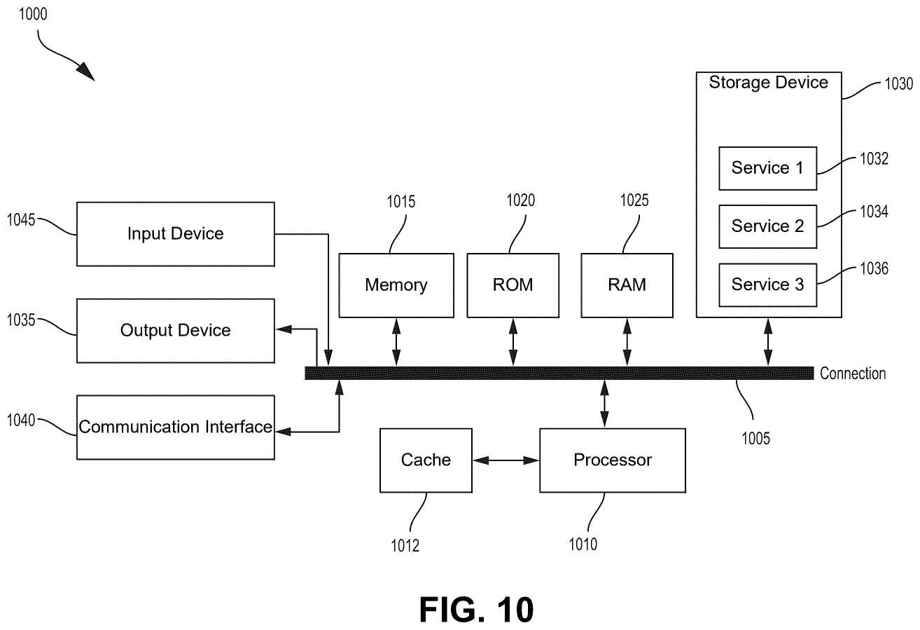

The image processor 150 may include one or more processors, such as one or more image signal processors (ISPs) (including ISP 154), one or more host processors (including host processor 152), and/or one or more of any other type of processor 1010 discussed with respect to the computing system 1000 of FIG. 10. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 902.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). An activation map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

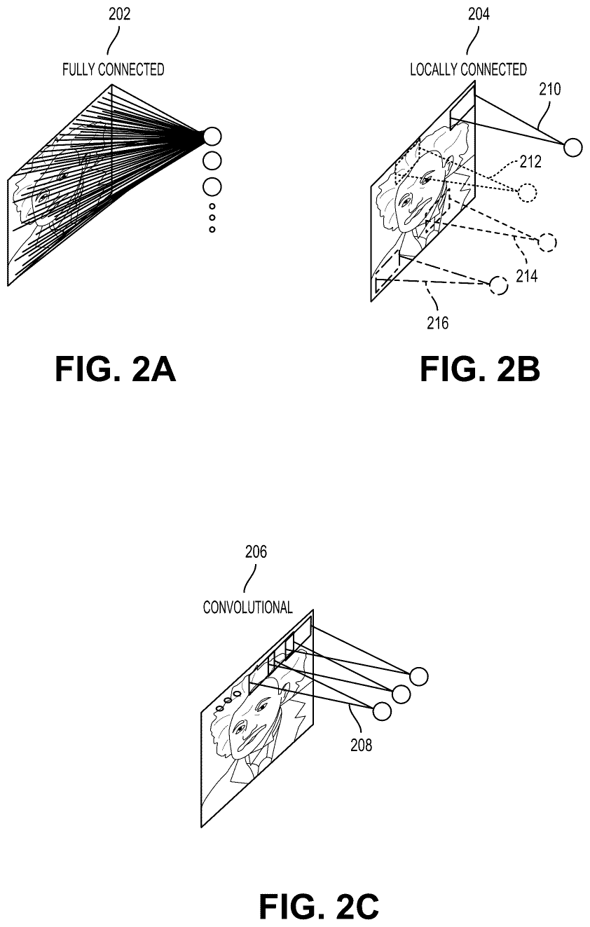

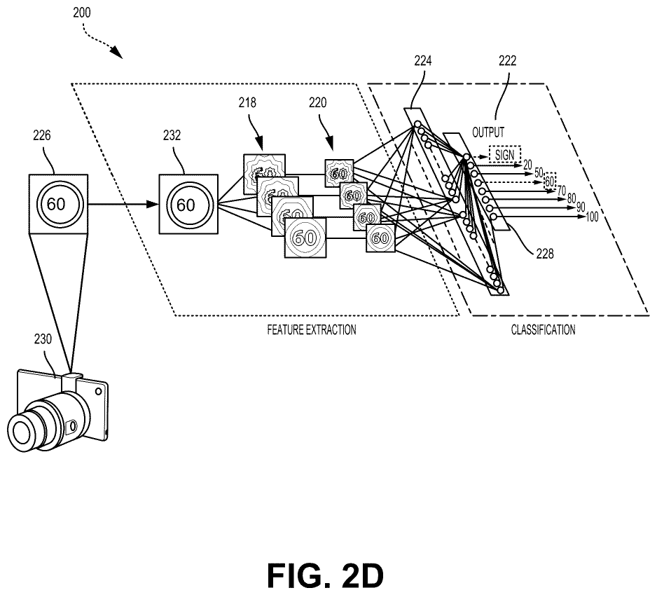

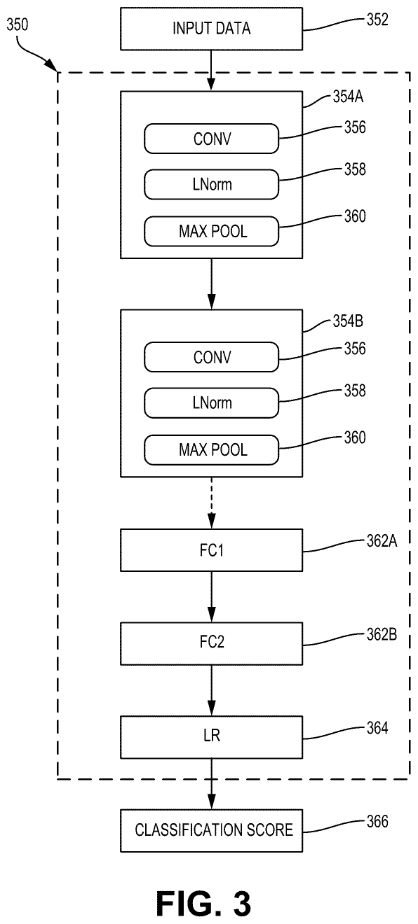

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section (also referenced herein as pixel decoder section) and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting, and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 1010 discussed with respect to the computing system 1000 of FIG. 10 to achieve high performance and low power consumption. In alternative aspects, the parallel filter banks may be loaded on a DSP or an ISP of the computing system 1000 of FIG. 10. In addition, the deep convolutional network 350 may access other processing blocks that may be present on the computing system 1000 of FIG. 10, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

As noted previously, transformer-based networks may be used for image segmentation in some cases. A transformer-based network can include a neural network that can learn context about features to try to detect patterns in data to determine how certain portions of the data may influence other portions. In some cases, a transformer-based network may tag features that are input to the transformer-based network. The transformer-based network may include attention units (e.g., self-attention units) that can be used to map how different features may be related. Using transformer-based networks for image segmentation can be resource intensive due to many redundant calculations, extensive scaling, and/or extensive post-processing, which can be even more resource-intensive for with relatively high-resolution images.

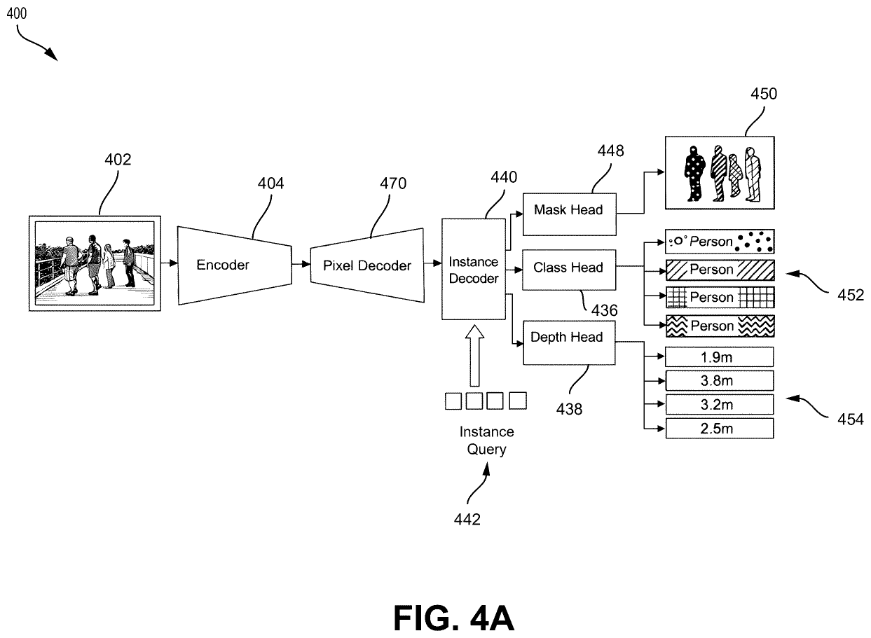

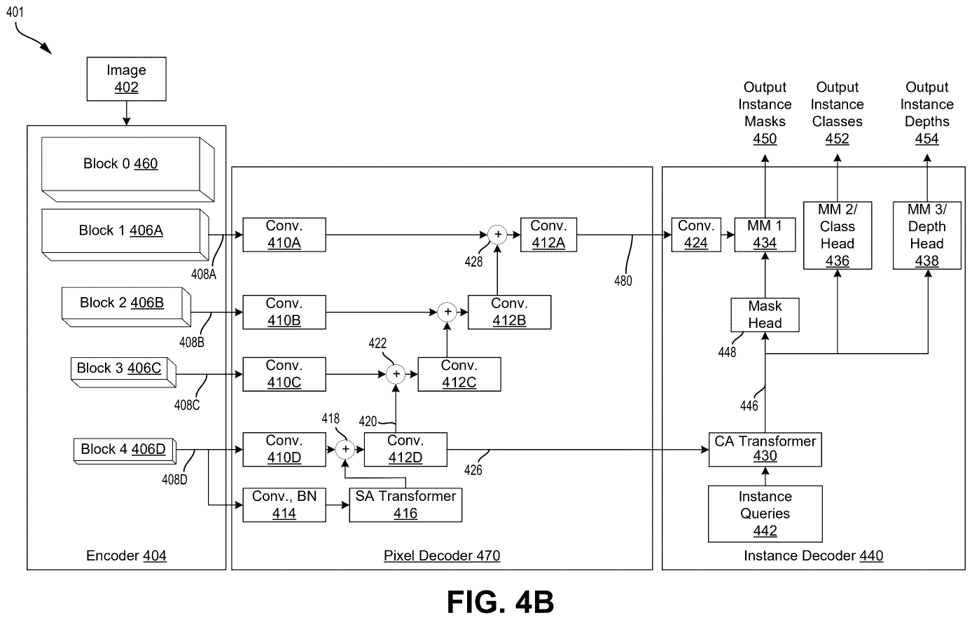

As discussed above, systems and techniques are described herein that provide a convolution and transformer-based image segmentation and depth estimation of features and/or each instance of objects in an image, for example, a two-dimensional (2D) image. FIG. 4A is a block diagram illustrating an example of a machine learning (ML) model 400 for performing image segmentation, in accordance with aspects of the present disclosure. As shown in FIG. 4A, image(s) 402 may be input into an encoder 404 portion of the ML model 400 (also referred as a “backbone”). In some cases, the encoder 404 may extract 2D spatial features (e.g., one or more feature maps) from the input image(s) 402.

The 2D spatial features (e.g., feature map(s)) extracted by the encoder 404 can be provided to a pixel decoder 470. The pixel decoder 470 can adapt the input feature maps to generate updated features (e.g., updated feature maps). The updated features are provided as input to an instance decoder 440 (which can also be referred to as output layers of the ML model 401).

The instance decoder 440 can process the updated features and one or more instance queries 442 using multiple output heads, such as a mask head 448, a class head 436, and/or a depth head 438. For example, the mask head 448 may be used to generate one or more instance masks 450 (also referred to as instance segmentation mask). The class head 436 may be used to generate one or more instance classes 452 (e.g., a class for an instance). The depth head 438 (also referred to as a depth prediction head) may be used to generate one or more instance depths 454 (e.g., depth information corresponding to an instance). In some aspects, the mask head 448 can include a matrix multiplier or can provide an output to the matrix multiplier to generate the instance mask(s) 450. In some cases, the depth head 438 can predict an absolute depth (e.g., in a unit of measurement, such as meters, feet, inches, etc.) of an instance and can make the depth(s) available as an extra attribute for the instance. For example, the instance depths 454 can indicate a depth or distance from a camera (e.g., used to capture the image 402) to each instance detected in the image 402. The depth prediction function of the depth head 438 can be deeply integrated into the query-based instance decoder 440, which can allow the predicted depths to be associated (e.g., automatically associated) with the existing prediction and thus avoid heavy computation in post-processing.

In the example of FIG. 4A, the instance mask 450 includes three different instances of a “person” class. The class head 436 may output labels for the different instances. In this example, as each instance of objects in the instance mask 450 is of the “person” class, the instance class 452 indicates the three different instances of the “person” class. In some aspects, the depth head 438 can predict a single depth value for each instance, instead of a depth for every single pixel. In some cases, predicting a single depth value for an instance may be usable, robust, and/or cost-effective in some application scenarios which may not benefit from more granular depth information. In the example shown in FIG. 4A, the instance depths 454 indicate a depth of 1.9 meters (m) for the first instance of the “person” class, a depth of 3.8 m for the second instance of the “person” class, and a depth of 3.2 m for the third instance of the “person” class.

FIG. 4B is a block diagram illustrating an example of a convolution and transformer-based machine learning (ML) model 401 for performing image segmentation, in accordance with aspects of the present disclosure. The ML model 401 includes examples of components that can be used for the encoder 404 (or “backbone”) portion of the ML model 400, the pixel decoder 470 of the ML model 400, and the instance decoder 440 of the ML model 400.

As shown, one or more image(s) 402 may be provided as input to the encoder 404 portion of the ML model 401. In some cases, the encoder 404 may extract 2D spatial features of the input image(s) 402. In some cases, the encoder 404 may be a CNN style backbone that may be used for CNN based image segmentation. For example, the encoder 404 may be similar to a backbone used in existing ML models such as ResNet50, MobileNetV2, or any similar CNN backbone. As an example, the MobileNetV2 backbone may be simplified to remove certain layers which may be either too computationally heavy or directed at image classification tasks.

In some cases, the encoder 404 may include multiple feature detector blocks 406A-406D (collectively feature detector blocks 406) which may generate and output feature maps from the image 402 at multiple scales. For example, feature detector block 1 406A may output 408A a feature map with a spatial scale of ¼ of the resolution of the original image 402, feature detector block 2 406B may output 408B a feature map with a spatial scale of ⅛ the resolution of the original image 402, and so forth. In some cases, the feature detector blocks 406 may include multiple sequential operation layers and features may be passed from feature detector block to feature detector block. In some cases, the multi-scale feature maps may provide feature maps of features in the image 402 at different semantic meaning levels (e.g., from more abstract features to more complex features). For example, feature detector blocks 406 associated with higher resolutions, as compared to the input image 402, may generate feature maps describing more abstract features, such as edges, corners, colors, and the like. Feature detector blocks 406 associated with lower resolutions may generate features maps describing more complex features, such as heads, arms, faces, etc. Feature detector blocks 406 associated with the lowest resolutions, such as feature detector block 4 406D, may generate feature maps describing the highest-level features, such as complete objects like a person, trees, pets, etc.

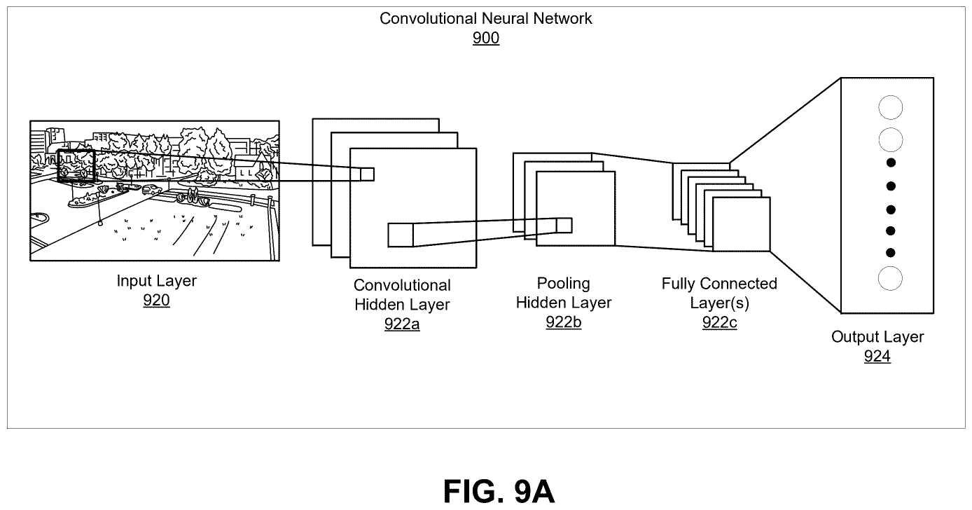

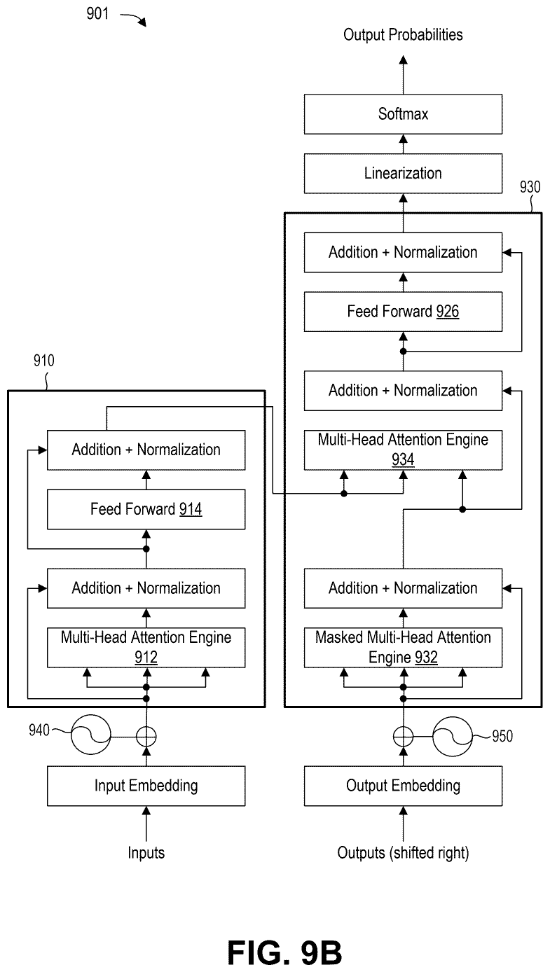

The output 408A-408D (collectively, output 408) feature maps, may be input to a respective one of the convolutional layers 410A-410D of the pixel decoder 470 to adapt the input feature maps. An example of a convolutional neural network (CNN) that can be used for one or more of the convolutional layers 410A-410D (and/or for one or more of the convolutional layers 412A-412D described below) is illustrated and described with respect to FIG. 9A. While four feature detector blocks 406 are shown, it may be understood that there may be any number of feature detector blocks 406 at different scales. In some cases, features may not be extracted to a feature map at all scales. For example, a feature map may not be extracted from feature detector block 0 460. In some cases, features may be processed by a feature detector block, such as feature detector block 0 460 and the processed features scaled and passed to other feature detector blocks 406 for further processing.

In some cases, output (e.g., feature maps) of some of the feature detector blocks may be used for feature adaption. For example, the output 408D of the feature detector block associated with the lowest resolution, such as feature detector block 4 406D may be used for feature adaption. In some cases, feature adaption may be performed using convolution and batch normalization layers 414 to generate adapted features. Adapting features may adjust a feature map so the feature map is more readily processed, for example, by a later layer.

The adapted features may be input to a self-attention transformer 416. The self-attention transformer 416 may determine a global attention for the feature map. For instance, the global attention may be a similarity score of feature pairs of the feature map, which may provide an indication of which features of the feature map are similar and which features are dissimilar. In some cases, the similarity score may be determined, for a first feature, as against every other feature of the feature map. In some cases, by scoring, on a per feature basis, features of the feature map against other features, the model may be able to distinguish instances of features (e.g., each person in an image may be a separate instance of a person feature). In some cases, the self-attention transformer 416 may be used on the lowest resolution feature map to reduce computational costs. In some cases, a self-attention transformer 416 and corresponding cross-attention transformers may be applied to feature maps of other resolutions to increase quality of results, at a cost of increased computational cost/complexity.

The determined similarity scores from the self-attention transformer 416 may then be added 418 back to the adapted feature map from convolutional layer 410D. In some cases, the similarity scores may be added using an element-wise addition operation. After the similarity scores are added 418 to the adapted feature map, the output of the addition may be adapted, for example, by a second convolution operation performed by a convolutional layer 412D to generate non-up-sampled feature extractor output 426. In some cases, a second feature extractor output 420 of the convolution operation performed by the convolutional layer 412D may be up-sampled so the up-sampled second feature extractor output 420 may be added 422 to an adapted feature map from a convolution operation associated with a higher resolution, such as a convolution operation performed by convolutional layer 410C, and adapted by a second convolution operation performed by a convolutional layer 412C. This process can then be repeated (e.g., using convolutional layer 412B) so that the similarity scores are up-sampled and propagated across the different resolutions (e.g., scales) until a convolution operation (e.g., performed by convolutional layer 410A) associated with a block (e.g., block 1 406A) with the highest resolution. The similarly scores and up-sampled lower resolution feature maps may be added 428 to the adapted feature map from the convolution operation performed by the convolutional layer 410A and adapted by the second convolution operation performed by a convolutional layer 412A to generate feature extractor output 480.

The feature extractor output 480 of the second convolution layer 412A may be input to the instance decoder 440. For example, the feature extractor output 480 may be passed to a convolution layer 424 of the instance decoder 440. An output from the convolution layer 424 may be passed to a matrix multiplier 434 of the instance decoder 440 to perform matrix multiplication operations. The non-up-sampled feature extractor output 426 may be output to a cross-attention transformer 430 (illustrated as CA transformer 430 in FIG. 4B) of the instance decoder 440. In some cases, the cross-attention transformer 430 may combine categories of features with received instance queries 442 (e.g., query 1 with a first person, query 2 with second person, and so forth).

For example, an instance query 442 for a particular a category (e.g., persons, vehicles, a particular animal, etc.) may be provided as input to the cross-attention transformer 430. The cross-attention transformer 430 may perform cross-attention based on the query using the non-up-sampled feature extractor output 426 to look for the queried information. This queried information may be passed to the mask head 448 as set of weights 446. The mask head 448 may generate an instance mask (e.g., segmentation mask) based on the queried information. A matrix multiplication of the instance mask may be performed by the matrix multiplier 434 to apply the instance mask to feature maps of the feature extractor output 480 to generate the output instance mask 450. In some cases, the instance decoder 440 may output a number of instance masks 450 (e.g., 10 instance masks) for different instances of the particular category (e.g., a person category resulting in instance masks of different people) detected in the image 402. In some cases, the instance query 442 may include an indication of (e.g., a request for) one or more categories for which to return instance masks 450 (e.g., an instance mask for a first category, an instance mask for a second category, etc.). In some cases, the instance query 442 may include an indication (e.g., a request) to return instance masks 450 for all categories for which the ML model 401 is trained to detect. In some cases, the categories for which the ML model 401 is trained to detect can be based on features detected at the lowest resolutions (e.g., based on block 4 406D). In some cases, there may be more instance masks 450 returned than there are instances of a category. For example, if the instance query 442 specifies returning 10 person instances and the input image includes 4 people, then six blank instance masks 450 may be returned along with four instance masks 450 of pixels corresponding with the 4 people in the image. In FIG. 4B, a certain number of instance masks is 10 instance masks, by default; however, the certain number of instance masks may be any value other than 10.

In addition to the instance masks, instance classes 452 may also be output. In some cases, instance classes 452 can help in identifying blank instances. In some cases, the instance classes 452 may be a vector or other data structure with a set of probability scores (e.g., confidence scores). Each probability score in the set of probability scores may indicate, for each of the instance masks, a probability or likelihood that an instance mask belongs to a target category (e.g., is a valid mask for an object/element of the target category). A selection of valid instance masks may be performed, for example, based on a threshold probability score.

In some cases, the instance queries 442 may be passed to the cross-attention transformer 430 of the instance decoder 440. The cross-attention transformer 430 may output a set of weights 446 based on the values of non-up-sampled feature extractor output 426 and the instance queries 442. An example of a transformer that can be used for the cross-attention transformer 430 is illustrated and described with respect to FIG. 9B.

The set of weights 446 may indicate how to combine feature maps along the channel dimension of a feature map (e.g., a channel for each recognized feature type) to generate final output masks. Output of the cross-attention transformer 430 may be input to a mask head 448, and output of the mask head 448 may be provided as input to a matrix multiplier 434. In some cases, the matrix multiplier 434 may be part of the mask head 448. The mask head 448 generates segmentation masks for each region using the aligned features to predict a binary mask for each object, delineating the pixel-wise boundaries of the instances.

The matrix multiplier 434 may perform a matrix multiplication between the weights and the adapted feature map output from the convolution layer 424 (e.g., from the feature extractor output 480). In this example, the highest resolution feature map (e.g., the feature map output by the first block 406A) is combined with the weights from the cross-attention transformers, but it may be understood that any feature map scale may be combined instead.

The instance masks 450, instance classes 452, and/or instance depths 454 may be output by the matrix multiplier 434, class head 436, and a depth head 438, respectively. In some cases, information for the instance classes 452 from the first cross-attention transformer 430 may be passed to the class head 436 to associate the output from the first cross-attention transformer 430 to the feature instances for output as the instance classes 452. Similarly, information for the instance depths 454 from the first cross-attention transformer 430 may be passed through the depth head 438 to associate the output from the first cross-attention transformer 430 to the depth instances for output as the instance depths 454.

While the instance decoder 440 of the ML model 401 is shown having one trainable query (e.g., instance queries 442), one cross-attention transformer (e.g., cross-attention transformer 430), and one matrix multiplication operation (e.g., matrix multiplier 434), in some examples, more than one trainable query, more than one cross-attention transformer, and more than one matrix multiplication operation may also be used. In accordance with aspects of the present disclosure, the instance queries 442 of the ML model 401 may be used to specify an output of the ML model 401. Instance queries 442 may thus be used to guide the model to focus on obtaining instance masks 450, and respective instance classes 452 and respective instance depths 454 associated with the instance masks 450. For example, the instance decoder 440 can output a particular number of instance masks 450, instance classes 452, and instance depths 454 (e.g., 10 instance masks, 10 instance classes, and 10 instance depths).

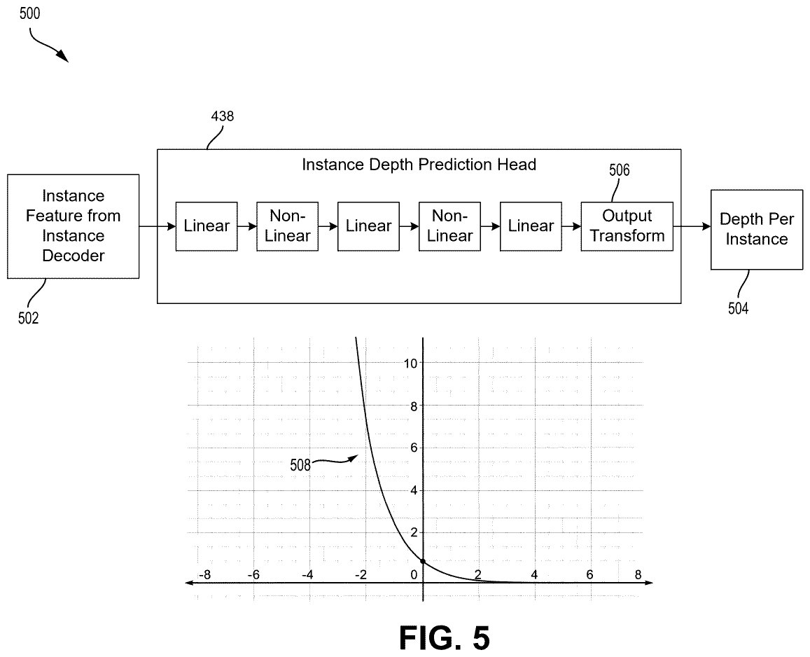

FIG. 5 illustrates an example diagram 500 of the depth prediction head 438 shown in FIG. 4B, in accordance with aspects of the present disclosure. As shown in FIG. 5, the depth head 438 receives instance feature 502 (e.g., the set of weights 446 of FIG. 4B), as an input from the instance decoder 440 of FIG. 4B. The depth head 438 (or depth prediction head), as described herein, can leverage an instance feature 502 from an instance decoder (e.g., the instance decoder 440 of FIG. 4A and/or FIG. 4B) to predict depth values 504 (e.g., in meters or other measure of distance or depth) for instances of an object identified in the image, potentially improving the accuracy and robustness of depth estimation tasks by incorporating instance-specific information.

As shown in FIG. 5, a series of linear layers (e.g., fully connected layers, multi-layer perceptrons (MLPs), and/or other linear layers) and non-linear layers (e.g., rectified linear unit (ReLU) layers, gated recurrent units (GRUs), and/or other non-linear layers) can process the instance feature 502 to generate an output transform 506. For example, instance features 502 may include features that provide information about depth, such as relative sized of certain features, where in an image certain features are located as compared to other features, etc. The linear layers and non-linear layers of the depth prediction head 438 may learn to predict the depth associated with an object based on such features and patterns of features.

The output transform 506 can process an output from the last linear layer of the instance depth prediction head 438 to generate a depth value for each detected instance. In some aspects, the output transform 506 can be a non-linear transform, which can help in predicting larger values. For instance, the non-linear transform (as an example of the output transform 506) can be defined as follows:

$$\frac{1}{σ ( x )} - 1$$

In some cases, it can be difficult to train a machine learning model or a CNN to directly predict particular relatively larger depths (e.g., depths of 10 meters, 20 meters, etc.), for example, due to gradient calculations. The non-linear transform shown by the above equation allows a smaller range of values (e.g., between ~−2 to 2 as shown in graph 508) to be mapped to a larger, more useful range (e.g., real-world distances) to help ease training the machine learning model.

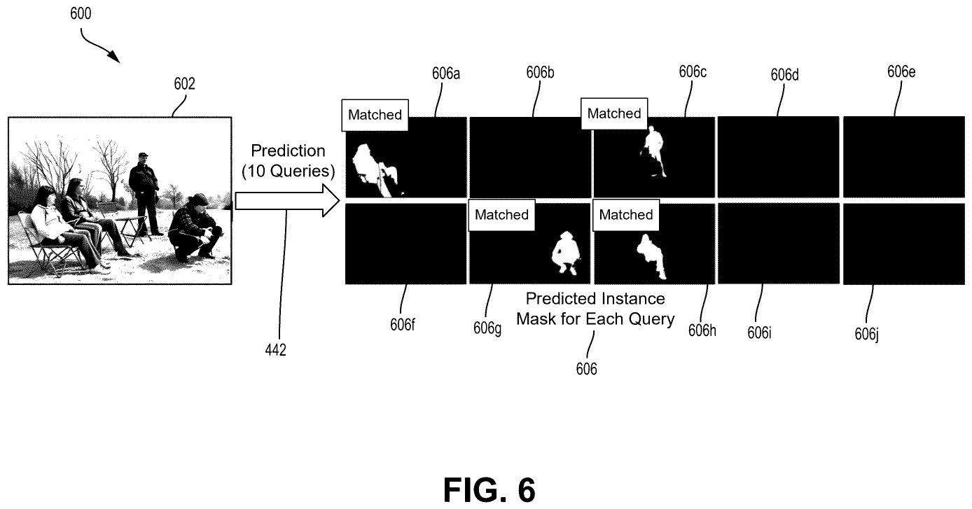

The instance decoder 440 may be a query-based instance decoder. An example diagram 600 shown in FIG. 6 illustrates training details of the query-based instance decoder 440, in accordance with aspects of the present disclosure. As shown in FIG. 6, for an image 602, such as a red-green-blue (RGB) image, instance queries 442 may be received. The instance queries 442 may be to identify 10 different instances of an object, for example, persons in the image 602. Based upon the instance queries 442, 10 different instance masks 606a-606j, collectively referenced herein as instance masks 606, may be generated.

As shown in FIG. 4A and FIG. 4B, the query-based instance decoder 440 may predict instance attributes for each instance. Instance attributes of each instance may include a mask (e.g., instance mask(s) 450 output by mask head 448), a class (e.g., instance class(es) 452 output by class head 436), and a depth (e.g., instance depth(s) 454 output by mask head 448). A matching algorithm may be performed to match the prediction with ground truth in order to determine a loss or error. The loss or error can then be used to perform backpropagation to train parameters (e.g., weights) of the ML system, including the query-based instance decoder 440, such as using the training techniques described with respect to FIG. 9B. For example, a matching algorithm may compare mask 606a with ground truth instance masks for the image 602 to determine whether mask 606a should be matched with a corresponding ground truth instance mask. As mask 606a is not completely masked out and may resemble a ground truth mask for the image, the mask 606a, and corresponding class and depth, may be matched with a ground truth instance mask to determine a loss. As another example, the matching algorithm may determine that as mask 606b is completely masked out, mask 606b does not match with any of the ground instance mask and mask 606b may be discarded. A class prediction may be used to identify which images may be matched against the ground truth. This matching may be performed for each instance mask 606a-606j to determine that instant masks 606a, 606c, 606g, and 606h may be matched with ground truth instance masks to determine the loss. Depth loss may be calculated, for example, to handle a wide range of depth predictions.

Accordingly, aspects of the present disclosure predict a depth of each instance of an object in an image using an instance level depth prediction head 438 shown in FIG. 4A, FIG. 4B, and FIG. 5. The depth prediction function of the depth prediction head 438 may be deeply integrated into the query-based instance decoder 440 such that the predicted depth is automatically associated with a prediction of instances of an object and thereby avoiding heavy computation in post-processing tasks. As described herein, the depth head 438 may predict a single depth value for each instance of the object instead of a per-pixel depth for the object. In some cases, the depth value may be provided in any unit of measurement, such as metric, imperial, etc.

Accordingly, aspects described herein enables estimating depth at instance level using a single image input, while reducing difficulty associated with training a machine learning model or a CNN. Aspects described herein can make the network lighter and more efficient for a wide range of applications or use cases. Example applications or use cases include, but not limited to only, foreground prediction, auto focus, auto tracking, image/video bokeh (or cinematic mode), an extended reality (XR) application, a wellness application, etc. Foreground prediction separates foreground instances from background instances based on their respective distance from the camera (or to the camera). Auto focus adjusts the focus plane to the distance of the focusing object or focusing instance. Auto tracking in which depth information is used to provide an extra dimension for object tracking. The depth information makes auto tracking easier. In the cinematic mode, depth information helps with generating a bokeh effect in which certain parts of an image are intentionally blurred to create a dreamy and/or eye-catching look. In the XR application, the aspects described herein help with detecting potential collision in a virtual reality (VR) mode and rendering objects with occlusion in a mixed reality (MR) mode and/or an augmented reality (AR) mode. Example wellness application may include an application reminding a user when they are too close to a screen. Accordingly, the described aspects have many real-life applications including AI camera features, collision alert or dynamic rendering features of XR glasses, wellness features, as described herein.

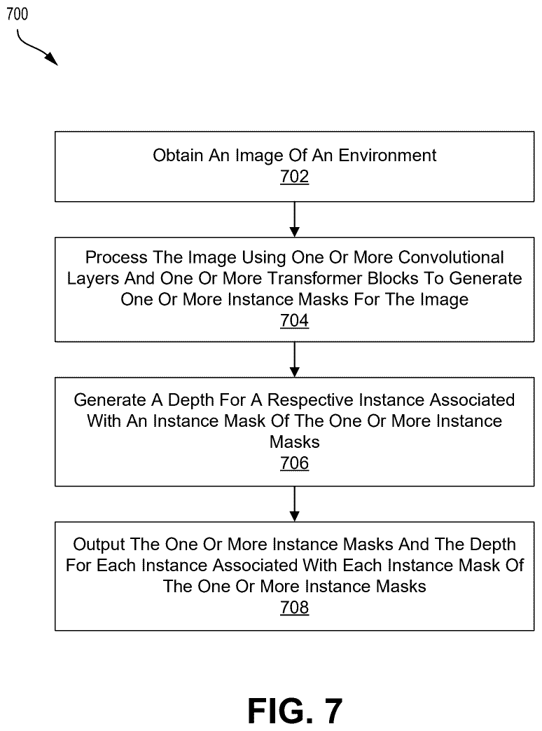

FIG. 7 is a flow diagram illustrating a process 700 for processing image data, in accordance with aspects of the present disclosure. The process 700 may be performed by a computing device (or apparatus) or a component (e.g., a chipset, codec, etc.) of the computing device, such as image capturing and processing system 100 of FIG. 1, the ML model 400 of FIG. 4A, the ML model 401 of FIG. 4B, and/or other system described herein. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the image processor 150 of FIG. 1, the host processor 152 of FIG. 1, processor 1010 of FIG. 10, and/or other processor(s)). In some cases, the operations of the process 700 can be implemented by a system having the architecture of computing system 1000 of FIG. 10.

At block 702, the computing device (or component thereof) may obtain an image (e.g., image 402 shown in FIG. 4A and/or FIG. 4B) of an environment.

At block 704, the computing device (or component thereof) may process the image using one or more convolutional layers and one or more transformer blocks to generate one or more instance masks for the image. For instance, the computing device (or component thereof) may extract a first set of features at a first scale resolution of the image. For example, the computing device (or component thereof) may include a ML model, such as ML model 401, with a backbone, such as encoder 404 and/or pixel decoder 470, for extracting features.

The computing device (or component thereof) may extract a second set of features (e.g., at block 4 406D of FIG. 4B) at a second scale resolution of the image, wherein the second scale resolution is lower than the first scale resolution. In some cases, the second set of features are extracted at the lowest scale resolution of all of the extracted sets of features for the image. In some cases, the first set of features and the second set of features are extracted using a convolutional neural network-based backbone. Examples of such a backbone may include ResNet50, MobileNetV2, or any similar CNN backbone. In some examples, the computing device (or component thereof) may perform a convolution operation and batch normalization operation (e.g., by convolution and batch normalization layers 414 of FIG. 4B) on the second set of features.

The computing device (or component thereof) may perform a self-attention transform (e.g., by a self-attention transformer 416 of FIG. 4B) to generate similarity scores for the second set of features. The computing device (or component thereof) may add (e.g., added 418) the similarity scores to the second set of features to generate a first feature extractor output. In some cases, the computing device (or component thereof) may generate the first feature extractor output by performing a convolution operation (e.g., convolution operation performed by convolutional layer 412D of FIG. 4B) on the added similarity scores and the second set of features.

The computing device (or component thereof) may up-sample the first feature extractor output (e.g., second feature extractor output 420 of FIG. 4B) to generate a second feature extractor output. In some cases, up-sampling allows the feature extractor output to be added to a feature map having a higher resolution. The computing device (or component thereof) may add (e.g., added 428 of FIG. 4B) the second feature extractor output to the first set of features to generate a third feature extractor output (e.g., third feature extractor output 480 of FIG. 4B).

The computing device (or component thereof) may receive an instance query (e.g., instance query 442 of FIG. 4B) for instances of a feature. In some cases, the feature received with the instance query is associated with a feature of the second set of features. In some cases, the instance query indicates a number of instances of a feature to output.

In some aspects, the computing device (or component thereof) may perform a cross-attention transform (e.g., by cross-attention transformer 430 of FIG. 4B) on the instance query and the first feature extractor output to generate a first set of weights. In some cases, the computing device (or component thereof) may obtain a set of probability scores based on the cross-attention transform. For example, instance classes, such as instance class 452, may be a vector with a set of probability scores. In some cases, the computing device (or component thereof) may associate probability scores of the set of probability scores with feature instances. For example, the probability scores may be arranged in the vector in an order corresponding with instances of a feature. In some cases, the computing device (or component thereof) may output the probability scores.

In some cases, the computing device (or component thereof) may perform a matrix multiplication (e.g., by first matrix multiplier 434 of FIG. 4B) on the first set of weights and the third feature extractor output to generate instance masks for the image.

At block 706, the computing device (or component thereof) may generate a depth for a respective instance associated with an instance mask of the one or more instance masks for the image. For instance, the computing device (or component thereof) may generate the as a single depth value for the respective instance.

At block 708, the computing device (or component thereof) may output the one or more instance masks and the dept for each instance associated with each instance mask of the one or more instance masks.

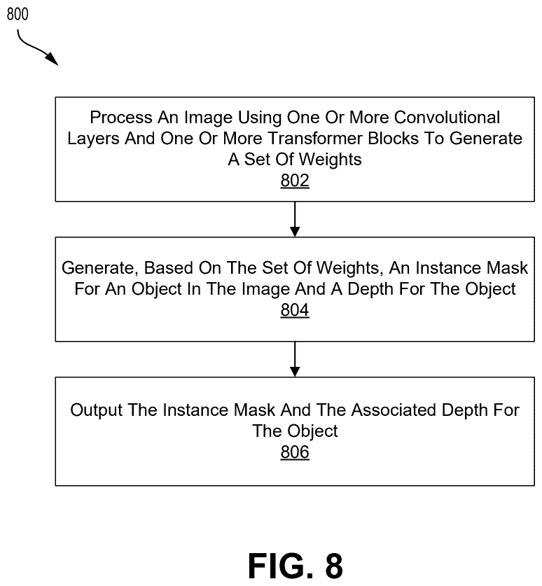

FIG. 8 is a flow diagram illustrating a process 800 for processing image data, in accordance with aspects of the present disclosure. The process 800 may be performed by a computing device (or apparatus) or a component (e.g., a chipset, codec, etc.) of the computing device, such as image capturing and processing system 100 of FIG. 1, the ML model 400 of FIG. 4A, the ML model 401 of FIG. 4B, and/or other system described herein. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., the image processor 150 of FIG. 1, the host processor 152 of FIG. 1, processor 1010 of FIG. 10, and/or other processor(s)). In some cases, the operations of the process 800 can be implemented by a system having the architecture of computing system 1000 of FIG. 10.

At block 802, the computing device (or component thereof) may process an image (e.g., image 226 of FIG. 2D, image(s) 402 of FIGS. 4A and 4B, image 602 of FIG. 6, etc.) using one or more convolutional layers (e.g., convolutional layers 410A-410D of FIG. 4B, convolutional layer 412A-412D of FIG. 4B, convolution and batch normalization layers 414 of FIG. 4B, etc.) and one or more transformer blocks (e.g., self-attention transformer 416 of FIG. 4B, cross-attention transformer 430 of FIG. 4B, etc.) to generate a set of weights. In some cases, the computing device (or component thereof) may process the set of weights using a linear layer and a non-linear layer (e.g., of depth head 438 of FIG. 4B and FIG. 5) to generate the depth for the object. In some cases, the computing device (or component thereof) may to process the image using the one or more convolutional layers and the one or more transformer blocks to generate the set of weights by: extracting a first set of features from the image at a first scale resolution, extracting a second set of features from the image at a second scale resolution, performing a self-attention transform to generate similarity scores for the second set of features, adding the similarity scores to the second set of features to generate a first feature extractor output, and performing a cross-attention transform on an instance query and the first feature extractor output to generate the set of weights. In some examples, the second scale resolution is lower than the first scale resolution. In some cases, the computing device (or component thereof) may up-sample the first feature extractor output to generate a second feature extractor output (e.g., second feature extractor output 420 of FIG. 4B), add (e.g., added 422 of FIG. 4B) the second feature extractor output to the first set of features to generate a third feature extractor output, receive an instance query (e.g., instance queries 442 of FIG. 4B) for instances of a feature, and perform a matrix multiplication (e.g., by matrix multiplier 434 of FIG. 4B) on the set of weights and the third feature extractor output (e.g., output from convolutional layers 410A of FIG. 4B) to generate instance masks for the image. In some examples, the feature received with the instance query is associated with a feature of the second set of features.

At block 804, the computing device (or component thereof) may generate, based on the set of weights, an instance mask (e.g., one or more instance masks 450 of FIGS. 4A and 4B, instance masks 606 of FIG. 6, etc.) for an object in the image and a depth (e.g., instance depth(s) 454 of FIG. 4B, depth values 504 of FIG. 5, etc.) for the object. In some cases, the depth is associated with the instance mask. In some examples, the depth is a single depth value for object. In some cases, the computing device (or component thereof) may perform a non-linear transform (e.g., output transform 506 of FIG. 5) on an output of the linear layer to generate the depth of the object. In some examples, the linear layer comprises at least one of a fully connected layer or a multi-layer perceptron. In some cases, the non-linear layer comprises at least one of a rectified linear unit (ReLU) layer or gated recurrent units (GRUs). In some examples, the computing device (or component thereof) may generate the first feature extractor output by performing a convolution operation (e.g., by convolutional layer 412D of FIG. 4B) on the added similarity scores and the second set of features.

At block 806, the computing device (or component thereof) may output the instance mask and the associated depth for the object.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the processes 700, 800, and/or other processes described herein may include a processor, microprocessor, micro-computer, or other component of a device that is configured to carry out the steps of the processes 700, 800, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the processes 700, 800, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 700 and 800 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the processes 700, 800, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As described herein, various types of machine learning models or systems can be used to implement aspects of the described systems and techniques, such as CNNs, transformer-based networks, etc. e with 28 rows and 28 columns of pixels and 3 color components (e.g., red, green, and blue, or luma and two chroma components, or the like). The image can be passed through a convolutional hidden layer 922a, an optional non-linear activation layer, a pooling hidden layer 922b, and fully connected hidden layers 922c to get an output at the output layer 924. While only one of each hidden layer is shown in FIG. 9A, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 is the convolutional hidden layer 922a. The convolutional hidden layer 922a analyzes the image data of the input layer 920. Each node of the convolutional hidden layer 922a is connected to a region of nodes (pixels) of the input image called a receptive field. The convolutional hidden layer 922a can be considered as one or more filters (each filter corresponding to a different activation or feature map), with each convolutional iteration of a filter being a node or neuron of the convolutional hidden layer 922a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 922a. Each connection between a node and a receptive field for that node learns a weight and, in some cases, an overall bias such that each node learns to analyze its particular local receptive field in the input image. Each node of the hidden layer 922a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 922a is due to each node of the convolutional layer being applied to its corresponding receptive field. For example, a filter of the convolutional hidden layer 922a can begin in the top-left corner of the input image array and can convolve around the input image. As noted above, each convolutional iteration of the filter can be considered a node or neuron of the convolutional hidden layer 922a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 922a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 922a.

The mapping from the input layer to the convolutional hidden layer 922a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 922a can include several activation maps in order to identify multiple features in an image. The example shown in FIG. 9A includes three activation maps. Using three activation maps, the convolutional hidden layer 922a can detect three different kinds of features, with each feature being detectable across the entire image.

In some examples, a non-linear hidden layer can be applied after the convolutional hidden layer 922a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 900 without affecting the receptive fields of the convolutional hidden layer 922a.

The pooling hidden layer 922b can be applied after the convolutional hidden layer 922a (and after the non-linear hidden layer when used). The pooling hidden layer 922b is used to simplify the information in the output from the convolutional hidden layer 922a. For example, the pooling hidden layer 922b can take each activation map output from the convolutional hidden layer 922a and generates a condensed activation map (or feature map) using a pooling function. Max-pooling is one example of a function performed by a pooling hidden layer. Other forms of pooling functions be used by the pooling hidden layer 922a, such as average pooling, L2-norm pooling, or other suitable pooling functions. A pooling function (e.g., a max-pooling filter, an L2-norm filter, or other suitable pooling filter) is applied to each activation map included in the convolutional hidden layer 922a. In the example shown in FIG. 9A, three pooling filters are used for the three activation maps in the convolutional hidden layer 922a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 922a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 922a having a dimension of 24×24 nodes, the output from the pooling hidden layer 922b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 922b to every one of the output nodes in the output layer 924. Using the example above, the input layer includes 28×28 nodes encoding the pixel intensities of the input image, the convolutional hidden layer 922a includes 3×24×24 hidden feature nodes based on application of a 5×5 local receptive field (for the filters) to three activation maps, and the pooling layer 922b includes a layer of 3×12×12 hidden feature nodes based on application of max-pooling filter to 2×2 regions across each of the three feature maps. Extending this example, the output layer 924 can include ten output nodes. In such an example, every node of the 3×12×12 pooling hidden layer 922b is connected to every node of the output layer 924.

The fully connected layer 922c can obtain the output of the previous pooling layer 922b (which should represent the activation maps of high-level features) and determines the features that most correlate to a particular class. For example, the fully connected layer 922c layer can determine the high-level features that most strongly correlate to a particular class, and can include weights (nodes) for the high-level features. A product can be computed between the weights of the fully connected layer 922c and the pooling hidden layer 922b to obtain probabilities for the different classes. For example, if the CNN 900 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 924 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9B is a block diagram of an example of a transformer 901 (also referred to as a transformer model or transformer neural network), in accordance with some aspects of the disclosure. In a CNN model, the number of operations required to relate signals from two arbitrary input or output positions grows in the distance between positions, which makes learning dependencies at different distant positions challenging for a CNN model. A transformer 901 reduces the operations of learning dependencies by using an encoder 910 and a decoder 930 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 910 is composed of a stack of six identical layers and each layer has two sub-layers. The first sub-layer is a multi-head self-attention engine 912, and the second sub-layer is a fully connected feed-forward network 914. A residual connection (not shown) connects around each of the sub-layers followed by normalization.

In this example transformer 901, the decoder 930 is also composed of a stack of six 6 identical layers. The decoder also includes a masked multi-head self-attention engine 932, a multi-head attention engine 934 over the output of the encoder 910, and a fully connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution and relative or absolute position of the tokens is needed. In the transformer 901, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 901 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 901 can process input sequences of variable length, making it well-suited for natural language processing tasks where input lengths can vary greatly. Additionally, the self-attention mechanism allows the transformer 901 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer-based networks.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some examples, computing system 1000 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, camera, accelerometers, gyroscopes, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 902.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some examples, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for image processing, comprising: at least one memory; and at least one processor coupled to the at least one memory and configured to: obtain an image of an environment; process the image using one or more convolutional layers and one or more transformer blocks to generate one or more instance masks for the image; generate a depth for a respective instance associated with an instance mask of the one or more instance masks; and output the one or more instance masks and the depth for each instance associated with each instance mask of the one or more instance masks.

Aspect 2. The apparatus of Aspect 1, wherein the depth is generated as a single depth value for the respective instance.

Aspect 3. The apparatus of any of Aspects 1 or 2, wherein, to process the image using the one or more convolutional layers and the one or more transformer blocks to generate the one or more instance masks for the image, the at least one processor is configured to: extract a first set of features at a first scale resolution of the image; extract a second set of features at a second scale resolution of the image, wherein the second scale resolution is lower than the first scale resolution; perform a self-attention transform to generate similarity scores for the second set of features; add the similarity scores to the second set of features to generate a first feature extractor output; up-sample the first feature extractor output to generate a second feature extractor output; add the second feature extractor output to the first set of features to generate a third feature extractor output; receive an instance query for instances of a feature; perform a cross-attention transform on the instance query and the first feature extractor output to generate a first set of weights; and perform a matrix multiplication on the first set of weights and the third feature extractor output to generate instance masks for the image.

Aspect 4. The apparatus of Aspect 3, wherein the feature received with the instance query is associated with a feature of the second set of features.

Aspect 5. The apparatus of any of Aspects 3 or 4, wherein, to generate the first feature extractor output, the at least one processor is configured to perform a convolution operation on the added similarity scores and the second set of features.

Aspect 6. The apparatus of any of Aspects 3 to 5, wherein the first set of features and the second set of features are extracted using a convolutional neural network-based backbone.

Aspect 7. The apparatus of any of Aspects 3 to 6, wherein the at least one processor is configured to: obtain a set of probability scores based on the cross-attention transform; associate probability scores of the set of probability scores with feature instances; and output the probability scores.

Aspect 8. The apparatus of any of Aspects 3 to 7, wherein the second set of features are extracted at a lowest scale resolution of all of the extracted first and second sets of features for the image.

Aspect 9. The apparatus of any of Aspects 3 to 8, wherein the at least one processor is configured to perform a convolution operation and batch normalization operation on the second set of features.

Aspect 10. The apparatus of any of Aspects 3 to 9, wherein the instance query indicates a number of instances of a feature to output.

Aspect 11. A method for image processing, comprising: obtaining an image of an environment; processing the image using one or more convolutional layers and one or more transformer blocks to generate one or more instance masks for the image; generating a depth for a respective instance associated with an instance mask of the one or more instance masks; and outputting the one or more instance masks and the depth for each instance associated with each instance mask of the one or more instance masks.

Aspect 12. The method of Aspect 11, wherein the depth is generated as a single depth value for the respective instance.

Aspect 13. The method of any of Aspects 11 or 12, wherein processing the image using the one or more convolutional layers and the one or more transformer blocks to generate the one or more instance masks for the image comprises: extracting a first set of features at a first scale resolution of the image; extracting a second set of features at a second scale resolution of the image, wherein the second scale resolution is lower than the first scale resolution; performing a self-attention transform to generate similarity scores for the second set of features; adding the similarity scores to the second set of features to generate a first feature extractor output; up-sampling the first feature extractor output to generate a second feature extractor output; adding the second feature extractor output to the first set of features to generate a third feature extractor output; receiving an instance query for instances of a feature; performing a cross-attention transform on the instance query and the first feature extractor output to generate a first set of weights; and performing a matrix multiplication on the first set of weights and the third feature extractor output to generate instance masks for the image.

Aspect 14. The method of Aspect 13, wherein the feature received with the instance query is associated with a feature of the second set of features.

Aspect 15. The method of any of Aspects 13 or 14, wherein generating the first feature extractor output comprises performing a convolution operation on the added similarity scores and the second set of features.

Aspect 16. The method of any of Aspects 13 to 15, wherein the first set of features and the second set of features are extracted using a convolutional neural network-based backbone.

Aspect 17. The method of any of Aspects 13 to 16, further comprising: obtaining a set of probability scores based on the cross-attention transform; associating probability scores of the set of probability scores with feature instances; and outputting the probability scores.

Aspect 18. The method of any of Aspects 13 to 17, wherein the second set of features are extracted at a lowest scale resolution of all of the extracted first and second sets of features for the image.

Aspect 19. The method of any of Aspects 13 to 18, further comprising performing a convolution operation and batch normalization operation on the second set of features.

Aspect 20. The method of any of Aspects 13 to 19, wherein the instance query indicates a number of instances of a feature to output.

Aspect 21. A non-transitory computer-readable medium having stored thereon instructions that, when executed by at least one processor, cause the at least one processor to perform operations according to any of Aspects 11 to 20.

Aspect 22. An apparatus for generating virtual content in a distributed system, the apparatus including one or more means for performing operations according to any of Aspects 11 to 20.

Aspect 23. An apparatus for image processing, comprising: at least one memory; and at least one processor coupled to the at least one memory and configured to: process an image using one or more convolutional layers and one or more transformer blocks to generate a set of weights; generate, based on the set of weights, an instance mask for an object in the image and a depth for the object, wherein the depth is associated with the instance mask; and output the instance mask and the associated depth for the object.

Aspect 24. The apparatus of Aspect 23, wherein the depth is a single depth value for object.

Aspect 25. The apparatus of any of Aspects 23-24, wherein the at least one processor is further configured to process the set of weights using a linear layer and a non-linear layer to generate the depth for the object.

Aspect 26. The apparatus of Aspect 25, wherein the at least one processor is configured to perform a non-linear transform on an output of the linear layer to generate the depth of the object.

Aspect 27. The apparatus of any of Aspects 25-26, wherein the linear layer comprises at least one of a fully connected layer or a multi-layer perceptron.

Aspect 28. The apparatus of any of Aspects 25-27, wherein the non-linear layer comprises at least one of a rectified linear unit (ReLU) layer or gated recurrent units (GRUs).

Aspect 29. The apparatus of any of Aspects 23-28, wherein, to process the image using the one or more convolutional layers and the one or more transformer blocks to generate the set of weights, the at least one processor is configured to: extract a first set of features from the image at a first scale resolution; extract a second set of features from the image at a second scale resolution, wherein the second scale resolution is lower than the first scale resolution; perform a self-attention transform to generate similarity scores for the second set of features; add the similarity scores to the second set of features to generate a first feature extractor output; and perform a cross-attention transform on an instance query and the first feature extractor output to generate the set of weights.

Aspect 30. The apparatus of Aspect 29, wherein the at least one processor is further configured to: up-sample the first feature extractor output to generate a second feature extractor output; add the second feature extractor output to the first set of features to generate a third feature extractor output; receive an instance query for instances of a feature; and perform a matrix multiplication on the set of weights and the third feature extractor output to generate instance masks for the image.

Aspect 31. The apparatus of any of Aspects 29-30, wherein the feature received with the instance query is associated with a feature of the second set of features.

Aspect 32. The apparatus of any of Aspects 29-31, wherein, to generate the first feature extractor output, the at least one processor is configured to perform a convolution operation on the added similarity scores and the second set of features.

Aspect 33. A method for image processing, comprising: processing an image using one or more convolutional layers and one or more transformer blocks to generate a set of weights; generating, based on the set of weights, an instance mask for an object in the image and a depth for the object, wherein the depth is associated with the instance mask; and outputting the instance mask and the associated depth for the object.

Aspect 34. The method of Aspect 33, wherein the depth is a single depth value for object.

Aspect 35. The method of any of Aspects 33-34, further comprising processing the set of weights using a linear layer and a non-linear layer to generate the depth for the object.

Aspect 36. The method of Aspect 35, further comprising performing a non-linear transform on an output of the linear layer to generate the depth of the object.

Aspect 37. The method of any of Aspects 35-36, wherein the linear layer comprises at least one of a fully connected layer or a multi-layer perceptron.

Aspect 38. The method of Aspect 35-38, wherein the non-linear layer comprises at least one of a rectified linear unit (ReLU) layer or gated recurrent units (GRUs).

Aspect 39. The method of any of Aspects 33-38, wherein processing the image using the one or more convolutional layers and the one or more transformer blocks to generate the set of weights includes: extracting a first set of features from the image at a first scale resolution; extracting a second set of features from the image at a second scale resolution, wherein the second scale resolution is lower than the first scale resolution; performing a self-attention transform to generate similarity scores for the second set of features; adding the similarity scores to the second set of features to generate a first feature extractor output; and performing a cross-attention transform on an instance query and the first feature extractor output to generate the set of weights.

Aspect 40. The method of Aspect 39, further comprising: up-sampling the first feature extractor output to generate a second feature extractor output; adding the second feature extractor output to the first set of features to generate a third feature extractor output; receiving an instance query for instances of a feature; and performing a matrix multiplication on the set of weights and the third feature extractor output to generate instance masks for the image.

Aspect 41. The method of any of Aspects 39-40, wherein the feature received with the instance query is associated with a feature of the second set of features.

Aspect 42. The method of Aspect 39-41, wherein generating the first feature extractor output includes performing a convolution operation on the added similarity scores and the second set of features.

Aspect 43. A non-transitory computer-readable medium having stored thereon instructions that, when executed by at least one processor, cause the at least one processor to perform operations according to any of Aspects 33 to 42.

Aspect 44. An apparatus for image processing, the apparatus including one or more means for performing operations according to any of Aspects 33 to 42.

What is claimed is:

1. An apparatus for image processing, comprising:
at least one memory; and
at least one processor coupled to the at least one memory and configured to:
process an image using one or more convolutional layers and one or more transformer blocks to generate a set of weights;
generate, based on the set of weights, an instance mask for an object in the image and a depth for the object, wherein the depth is associated with the instance mask; and
output the instance mask and the associated depth for the object.

2. The apparatus of claim 1, wherein the depth is a single depth value for object.

3. The apparatus of claim 1, wherein the at least one processor is further configured to process the set of weights using a linear layer and a non-linear layer to generate the depth for the object.

4. The apparatus of claim 3, wherein the at least one processor is configured to perform a non-linear transform on an output of the linear layer to generate the depth of the object.

5. The apparatus of claim 3, wherein the linear layer comprises at least one of a fully connected layer or a multi-layer perceptron.

6. The apparatus of claim 3, wherein the non-linear layer comprises at least one of a rectified linear unit (ReLU) layer or gated recurrent units (GRUs).

7. The apparatus of claim 1, wherein, to process the image using the one or more convolutional layers and the one or more transformer blocks to generate the set of weights, the at least one processor is configured to:
extract a first set of features from the image at a first scale resolution;
extract a second set of features from the image at a second scale resolution, wherein the second scale resolution is lower than the first scale resolution;
perform a self-attention transform to generate similarity scores for the second set of features;
add the similarity scores to the second set of features to generate a first feature extractor output; and
perform a cross-attention transform on an instance query and the first feature extractor output to generate the set of weights.

8. The apparatus of claim 7, wherein the at least one processor is further configured to:
up-sample the first feature extractor output to generate a second feature extractor output;
add the second feature extractor output to the first set of features to generate a third feature extractor output;
receive an instance query for instances of a feature; and
perform a matrix multiplication on the set of weights and the third feature extractor output to generate instance masks for the image.

9. The apparatus of claim 7, wherein the feature received with the instance query is associated with a feature of the second set of features.

10. The apparatus of claim 7, wherein, to generate the first feature extractor output, the at least one processor is configured to perform a convolution operation on the added similarity scores and the second set of features.

11. A method for image processing, comprising:
processing an image using one or more convolutional layers and one or more transformer blocks to generate a set of weights;
generating, based on the set of weights, an instance mask for an object in the image and a depth for the object, wherein the depth is associated with the instance mask; and
outputting the instance mask and the associated depth for the object.

12. The method of claim 11, wherein the depth is a single depth value for object.

13. The method of claim 11, further comprising processing the set of weights using a linear layer and a non-linear layer to generate the depth for the object.

14. The method of claim 13, further comprising performing a non-linear transform on an output of the linear layer to generate the depth of the object.

15. The method of claim 13, wherein the linear layer comprises at least one of a fully connected layer or a multi-layer perceptron.

16. The method of claim 13, wherein the non-linear layer comprises at least one of a rectified linear unit (ReLU) layer or gated recurrent units (GRUs).

17. The method of claim 11, wherein processing the image using the one or more convolutional layers and the one or more transformer blocks to generate the set of weights includes:
extracting a first set of features from the image at a first scale resolution;
extracting a second set of features from the image at a second scale resolution, wherein the second scale resolution is lower than the first scale resolution;
performing a self-attention transform to generate similarity scores for the second set of features;
adding the similarity scores to the second set of features to generate a first feature extractor output; and
performing a cross-attention transform on an instance query and the first feature extractor output to generate the set of weights.

18. The method of claim 17, further comprising:
up-sampling the first feature extractor output to generate a second feature extractor output;
adding the second feature extractor output to the first set of features to generate a third feature extractor output;
receiving an instance query for instances of a feature; and
performing a matrix multiplication on the set of weights and the third feature extractor output to generate instance masks for the image.

19. The method of claim 17, wherein the feature received with the instance query is associated with a feature of the second set of features.

20. The method of claim 17, wherein generating the first feature extractor output includes performing a convolution operation on the added similarity scores and the second set of features.
